(19) United States
(12) Patent Application Publication
(10) Pub. No.: US 2015/0131455 A1
(43) Pub. Date: May 14, 2015

(54) METHOD AND APPARATUS FOR SELECTIVELY PERFORMING PACKET ERROR CLASSIFICATION OF MULTIPLE PACKET STREAMS MULTIPLEXED TO SAME PORT

(71) Applicant: ELECTRONICS AND TELECOMMNICATIONS RESEARCH INTITUTE, Daejeon (KR)

(72) Inventors: Seong Jun Bae, Daejeon (KR); Hyun Woo Lee, Daejeon (KR); Won Ryu, Daejeon (KR)

(73) Assignee: ELECTRONICS AND TELECOMMNICATIONS RESEARCH INTITUTE, Daejeon (KR)

(21) Appl. No.: 14/415,437

(22) PCT Filed: Jul. 19, 2013
(86) PCT No.: PCT/KR2013/006479

§ 371 Date: Jan. 16, 2015

(30) Foreign Application Priority Data
Jul. 19, 2012 (KR) 10-2012-0078772
Jul. 19, 2013 (KR) 10-2013-0085042

(51) Int. Cl. H04L 12/939; H04N 19/66; H04L 29/06; H04L 1/20

(52) U.S. Cl. CPC H04L 49/552; H04L 1/201; H04N 19/66; H04L 69/22
USPC 370/242; 370/474

(57) ABSTRACT

A method and an apparatus for selectively performing packet error classification of multiple packet streams multiplexed to the same are provided. According to the method, generating an MMT packet can include: encapsulating an AU provided from a media codec layer to generate an MPU; and packetizing the generated MPU to generate the MMT packet. The MMT packet can include a packet header including a substream sequence number. Multiple substreams can be multiplexed and transmitted to a single port, and it is possible to detect, if a packet loss occurs, to which substream the lost packet belongs. Furthermore, based on this, an automatic repeat request (ARQ) can be made differently for each subframe and an error control policy can be taken differently for each subframe.

### TECHNICAL FIELD

The present invention relates to a method and apparatus of selective classification of a packet error of multiple packet streams and, more particularly, to a method and apparatus for selectively classifying a packet error of multiple packet streams multiplexed to the same port.

### BACKGROUND ART

Since MPEG-2 standardization, new video compression standards (or audio compression standard) such as MPEG-4, H.264/AVC, SVC (Scalable Video Coding) have steadily been developed for the past ten years. Also, the respective new standards, forming new markets, respectively, have extended utilization coverage of the MPEG standard, while transmission technologies such as MPEG-2 TS (Transport System) has also widely used in digital broadcast, mobile broadcast (T-DMB, DVB-H, etc.), and the like, in the markets steadfastly and widely utilized even in multimedia transmission through the Internet, i.e., IPTV services, which was not considered when the standards were stipulated.

However, since the development of a multimedia transmission environment, the multimedia transmission environment has undergone substantial changes. For example, the MPEG-2 TS standard was developed and stipulated in consideration of transmission of multimedia data via an ATM network, but it is very hard to find a case of using the MPET-2 TS standard for this purpose. Also, when the MPEG-2 TS standard was stipulated, requirements such as multimedia transmission using the Internet, and the like, were not considered, involving factors not effective for multimedia transmission via the Internet. Thus, in MPEG, MMT (MPEG Media Transport) has been established as a novel multimedia transmission standard in consideration of the changing multimedia environment.

Based on a media transmission technique, several packet streams may be multiplexed into substreams and transmitted to a single port. However, if a packet loss occurs, to which substream, the lost packet belonged before having been multiplexed cannot be recognized.

Thus, a novel media transmission technique for selectively recognizing a packet error of multiple packet streams multiplexed to the same port in consideration of a new media transmission environment and standard is required.

### DISCLOSURE

### Technical Problem

The present invention provides a method and apparatus for selectively classifying a packet error of multiple packet streams multiplexed to the same port.

The present invention also provides information regarding to which substream a lost packet belongs, when a packet loss occurs.

The present invention also provides a method and apparatus for selectively classifying multiplexed multiple packet streams

The present invention effectively classifies multiplexed multiple packet streams to allow for executing an individual error control policy.

### Technical Solution

In an aspect, an MMT (MPEG Media Transport) packet generating apparatus is provided. The MMT packet generating apparatus includes: an encapsulation unit configured to encapsulate an AU (Access Unit) provided from a media codec layer to generate an MPU (Media Processing Unit); and a packetization unit configured to packetize the generated MPU to generate an MMT packet, wherein the packetization unit generates the MMT packet having a packet header including a substream sequence number.

In another aspect, a method for generating a packet by an MMT (MPEG Media Transport) packet generating apparatus is provided. The MMT packet generating method includes: encapsulating an AU provided from a media codec layer to generate an MPU (Media Processing Unit); and packetizing the generated MPU to generate an MMT packet, wherein the MMT packet has a packet header including a substream sequence number.

In another aspect, a header structure of an MMT (MPEG Media Transport) packet in a system for generating an MMT packet. The header structure of the MMT packet basically includes a substream ID field and a substream sequence number field, and further includes a general sequence number flag field indicating the presence or absence of a general sequence number field.

### Advantageous Effects

According to embodiments of the present invention, a plurality of substreams are multiplexed and transmitted to a single port, and even when a packet loss occurs, to which substream the lost packet belongs can be recognized. Thus, different ARQ (Automatic Repeat reQuest) and error control policies can be executed for each substream.

### DESCRIPTION OF DRAWINGS

FIG. 1 is a conceptual view illustrating an MMT layer structure.

FIG. 2 is a flow chart illustrating a process of generating an MMT packet according to an embodiment of the present invention.

FIGS. 3 and 4 illustrate a concept of a substream_seqno field and a generic_seqno field and use cases of the substream_seqno.

FIG. 5 is a block diagram of an apparatus for generating an MMT packet according to an embodiment of the present invention.

### MODE FOR INVENTION

Hereinafter, embodiments will be described in detail with reference to the accompanying drawings such that they can be easily practiced by those skilled in the art to which the present invention pertains. However, the present invention may be implemented in various forms and not limited to the embodiments disclosed hereinafter. Also, in order to clarify the present invention, parts irrespective of description have been omitted, and similar reference numerals are used for the similar parts throughout the specification.

Throughout the specification, unless explicitly described to the contrary, the word “comprise” and variations such as “comprises” or “comprising”, will be understood to imply the inclusion of stated elements but not the exclusion of any other elements. In addition, the terms such as “-er”, “-or” and “module” described in the specification mean units for processing at least one function and operation and can be implemented by hardware components or software components and combinations thereof.

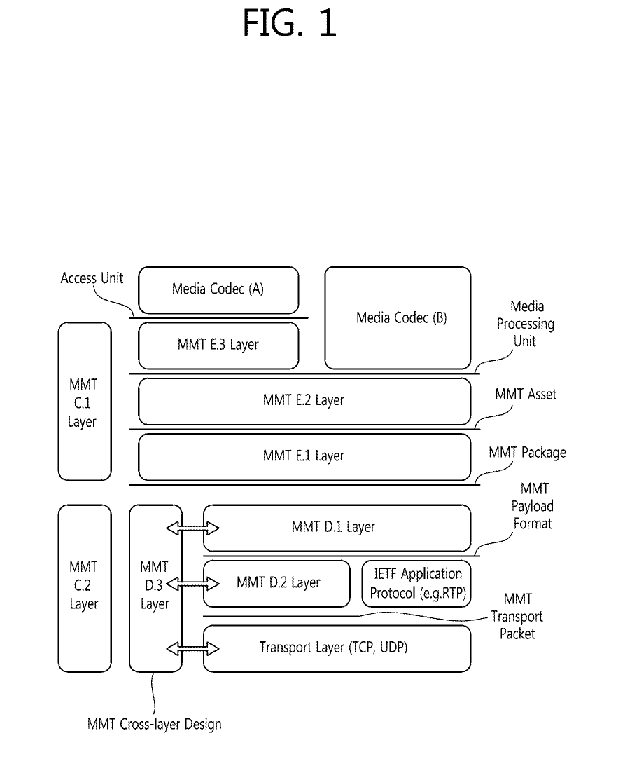

FIG. 1 is a conceptual view illustrating an MMT layer structure.

An MMT (MPEG Media Transport) layer includes an encapsulation layer, a delivery layer, and a signaling layer.

The encapsulation layer (E-layer) is a layer for packaging media data such that the data is friendly to both directions of a transmission application and an application for file storage in an IP network. As illustrated in FIG. 1, the E-layer may include an MMT E.1 Layer, an MMT E.2 Layer, and an MMT E.3 Layer.

The MMT E.3 layer encapsulates an access unit (AU) provided from a media codec (A) layer to generate a media processing unit (MPU). An AU, the smallest media data unit, may have timing information as an attribute thereof. Here, the timing information may be information regarding time, among information required for each media data to be consumed, and a CTS (Composition Time Stamp), a DTS (Decoding Time Stamp), and the like, may be included in the timing information.

The CTS refers to a time during which a corresponding AU is displayed on a screen, and the DTS refers to a time during which the corresponding AU is consumed in a decoder. A single MPU may include one or two or more AUs.

The MMT E.2 layer encapsulates an MPU generated in the MMT E.3 layer to generate an MMT asset. The MMT asset, a data entity including one or a plurality of MPUs, is multiplexed by an MMT payload format and transmitted by an MMT protocol. The MMT payload format is a format for payload of an MMT package or MMT signaling message to be transmitted by the MMT protocol or an Internet application layer protocol (e.g., an RTP). The MMT asset may correspond to PES (Packetized Elementary Stream) of an MPEG-2 TS. For example, the MMT asset may correspond to a video, audio, program information, an MPEG-U widget, a JPEG image, an MPEG 4 file format, M2TS (MPEG transport stream), and the like.

The MMT E.1 layer encapsulates the MMT asset generated in the MMT E.2 layer to generate an MMT package. The MMT package may include one or a plurality of MMT assets together with composition information and additional information such as transport characteristics. The composition information may include information regarding relationships between MMT assets, and in a case in which single content include a plurality of MMT packages, the composition information may further include information indicating relationships between the plurality of MMT packages. Transport characteristics may include transmission characteristics information required for determining a delivery condition of an MMT asset or an MMT packet. For example, the transport characteristics may include a traffic description parameter and a QoS descriptor. The MMT package may correspond to a program of an MPEG-2 TS.

Meanwhile, the delivery layer (D-layer) may include an MMT D.1 Layer, an MMT D.2 Layer, and an MMT D.3 Layer.

The MMT D.1 layer receives an MMT package generated in the MMT E.1 Layer and generates an MMT payload format. The MMT payload format is a payload format for transmitting an MMT asset and transmitting information for consumption by existing different application transport protocols such as an MMT application protocol or an RTP.

The MMT D.2 layer receives the MMT payload format generated in the MMT D.1 layer and generates an MMT transport packet or an MMT packet. The MMT transport packet or the MMT packet is a data format used for an application transport protocol for an MMT.

The MMT D.2 layer (D.3-layer) supports QoS (Quality of Service) by providing a function of exchanging information between layers by a cross-layer design. For example, the D.3 layer may perform QoS control by using a QoS parameter of a MAC/PHY layer.

Meanwhile, a signaling layer (S layer) performs a signaling function. For example, the signaling layer may perform a signaling function for session initialization/control/management of transmitted media, a server-based and/or client-based trick mode, service discovery, synchronization, and the like.

As illustrated in FIG. 1, the signaling layer may include an MMT S.1 Layer, and an MMT S.2 Layer.

The MMT S.1 layer may perform service discovery, media session initialization/termination, media session presentation/control, a function of interfacing with a transport layer and an encapsulation layer.

The MMT S.2 layer may define a format of a control message exchanged between delivery end-points of a transport layer regarding flow control, delivery session management, delivery session monitoring, error control, hybrid network synchronization control. Also, the MMT S.2 layer may provide signaling required between a sender and a receiver in order to support an operation of a delivery layer. Also, the MMT S.2 layer may handle a function of interfacing with a delivery layer and an encapsulation layer.

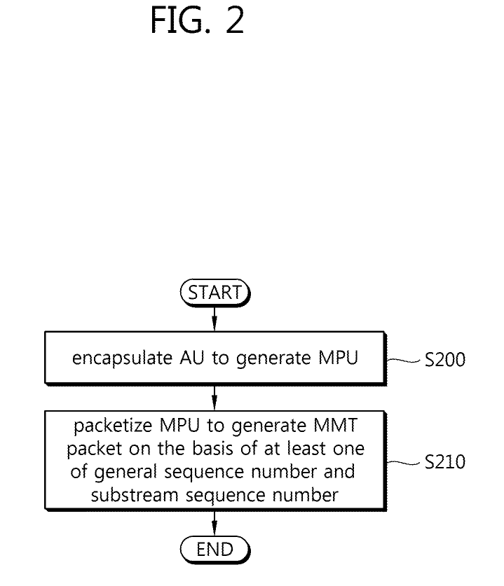

FIG. 2 is a flow chart illustrating a process of generating an MMT packet according to an embodiment of the present invention.

The apparatus for generating an MMT packet (or an MMT packet generating apparatus) according to an embodiment of the present invention generates an MMT packet according to the definition of the MMT layers as described above. Here, the MMT packet generating apparatus according to an embodiment of the present invention encapsulates an AU provided from a media codec layer to generate an MPU (S200), and packetize the generated MPU to generate an MMT packet (S210). In this case, the MMT packet generating apparatus optionally uses a sequence number in order to selectively classify a packet error of a plurality of packet streams multiplexed to the same port. In other words, in order to selectively classify a packet error of a plurality of packet streams multiplexed to the same port, the MMT packet generating apparatus according to an embodiment of the present invention generates an MMT packet on the basis of at least one of a substream sequence number and a general sequence number.

The MMT packet generating apparatus may generate an MMT packet optionally including various types of sequence numbers according to circumstances. In detail, a method for optionally using a sequence number by the MMT packet generating apparatus according to an embodiment of the present invention may include 1) basically using both a substream sequence number and a general sequence number, 2) optionally using a substream sequence number and basically using a general sequence number, 3) basically using a substream sequence number and optionally using a general sequence number, or 4) using only a substream sequence number. Before operation S210, the MMT packet generating apparatus may determine a sequence mode. In other words, the MMT packet generating apparatus may determine any one of the 1) to 4) as a sequence mode.

TABLE 1

| | | |
|---|---|---|
| Syntax | No. of bits | Mnemonic |

Packet ( ){

| | | |
|---|---|---|
| generic_seqno | 16 | unsigned int |
| substream_ID | 16 | unsigned int |
| substream_seqno | 16 | unsigned int |
| Packet_payload( ) | | |

}

Table 1 shows an MMT packet header structure according to an embodiment of the present invention. Table 1 shows a case in which both a substream sequence number and a general sequence number are basically used. The method of basically using both a substream sequence number and a general sequence number may be used, for example, in a case in which packet reordering and packet error processing are performed in units of overall multiplexed streams (or by overall multiplexed streams) and to which substream a lost packet belongs should be constantly checked.

Referring to Table 1, a header field of the MMT packet may include a generic_seqno field, a substream_ID field, and a substream_seqno field.

The generic_seqno field is a general sequence number increased by 1 in every packet in order in which packets are transmitted with respect to packet streams transmitted to the same port. The generic_seqno field may also be known as a packet_counter field. This is the same hereinafter.

The substream_ID field is an identifier for identifying individual streams when the (sub)streams having different characteristics are multiplexed into a single packet stream. The substream_ID field may also be known as a packet_id field. This is the same hereinafter.

The substream_seqno indicates a subframe sequence number increased by 1 in every packet with respect to packet streams having the same substream ID. A packet sequence number-based operation such as error check, error recovery, and the like, may be performed in units of substreams (or by subframes) by using the substream_seqno field. Namely, error control may be performed in units of subframes (or by subframes) by using the substream_seqno field included in a header field of an MMT packet received from an MMT packet receiving end. The substream_seqno field may also known as a packet_sequence_number field. This is the same hereinafter.

TABLE 2

| | | |
|---|---|---|
| Syntax | No. of bits | Mnemonic |

Packet ( ){

| | | |
|---|---|---|
| generic_seqno | 16 | Unsigned int |
| substream_ID | 16 | unsigned int |
| flag_substream_seqno | 1 | bit |
| if(flag_substream_seqno == ‘1’){ | | |

| | | |
|---|---|---|
| substream_seqno | 16 | unsigned int |

}
Packet_payload( )

}

Table 2 shows an MMT packet header structure according to another embodiment of the present invention. Table 2 shows a case in which a substream sequence number is optionally used and a general sequence number is basically used. The method of optionally using a substream sequence number and basically using a general sequence number may be used, for example, in a case in which packet reordering and packet error processing are performed in units of overall multiplexed streams (or by overall multiplexed streams) but to which substream a lost packet belongs may be selectively performed according to an application.

Referring to Table 2, a header field of the MMT packet may include a generic_seqno field, a substream_ID field, a flag_substream_seqno, and a substream_seqno field.

The generic_seqno field is a general sequence number increased by 1 in every packet in order in which packets are transmitted with respect to packet streams transmitted to the same port.

The substream_ID field is an identifier for identifying individual streams when the (sub)streams having different characteristics are multiplexed into a single packet stream.

The flag_substream_seqno field indicates whether a substream_seqno field exists in the header field. For example, when the flag_substream_seqno field has a value 1, it may indicate that the substream_seqno exists in the header field. The flag_substream_seqno field may also be known as a packet_sequence_number_flag. This is the same hereinafter.

The substream_seqno indicates a subframe sequence number increased by 1 in every packet with respect to packet streams having the same substream ID. A packet sequence number-based operation such as error check, error recovery, and the like, may be performed in units of substreams (or by subframes) by using the substream_seqno field.

TABLE 3

| | | |
|---|---|---|
| Syntax | No. of bits | Mnemonic |

Packet ( ){

| | | |
|---|---|---|
| substream_ID | 16 | Unsigned int |
| substream_seqno | 16 | unsigned int |
| flag_generic_seqno | 1 | bit |
| if(flag_generic_seqno == ‘1’){ | | |

| | | |
|---|---|---|
| generic_seqno | 16 | unsigned int |

}
Packet_payload( )

}

Table 3 shows an MMT packet header structure according to another embodiment of the present invention. Table 3 shows a case in which a substream sequence number is basically used and a general sequence number is optionally used. The method of basically using a substream sequence number and optionally using a general sequence number may be used, for example, in a case in which a receiver performs a packet error processing function or reordering function in units of overall multiplexed streams (or by overall multiplexed streams) and the entire sequence numbers are used only when sequence numbers of an overall stream unit are required.

Referring to Table 3, a header field of the MMT packet may include a substream_seqno field, a substream_ID field, a flag_generic_seqno, and a generic_seqno field.

The substream_ID field is an identifier for identifying individual streams when the (sub)streams having different characteristics are multiplexed into a single packet stream.

The substream_seqno indicates a subframe sequence number increased by 1 in every packet with respect to packet streams having the same substream ID. A packet sequence number-based operation such as error check, error recovery, and the like, may be performed in units of substreams (or by subframes) by using the substream_seqno field.

The flag_generic_seqno field indicates whether a generic_seqno field exists in the header field. For example, when the flag_generic_seqno field has a value 1, it may indicate that the generic_seqno exists in the header field. The flag_generic_seqno field may also be known as a packet_counter flag. This is the same hereinafter.

The generic_seqno field is a general sequence number increased by 1 in every packet in order in which packets are transmitted with respect to packet streams transmitted to the same port.

TABLE 4

| | | |
|---|---|---|
| Syntax | No. of bits | Mnemonic |

Packet ( ){

| | | |
|---|---|---|
| substream_ID | 16 | Unsigned int |
| substream_seqno | 16 | unsigned int |
| Packet_payload( ) | | |

}

Table 4 shows an MMT packet header structure according to another embodiment of the present invention. Table 4 shows a case in which only the substream sequence number is used. The method of using only the substream sequence number may be used, for example, in a case in which after substreams are demultiplexed in a receiver, whether there is a packet loss can be basically recognized by substreams and the substreams are formed as a single substream without being multiplexed so it can replace an existing function of a general sequence number.

Referring to Table 4, a header field of the MMT packet may include a substream_ID field and a substream_seqno field.

The substream_ID field is an identifier for identifying individual streams when the (sub)streams having different characteristics are multiplexed into a single packet stream.

The substream_seqno indicates a subframe sequence number increased by 1 in every packet with respect to packet streams having the same substream ID. A packet sequence number-based operation such as error check, error recovery, and the like, may be performed in units of substreams (or by subframes) by using the substream_seqno field.

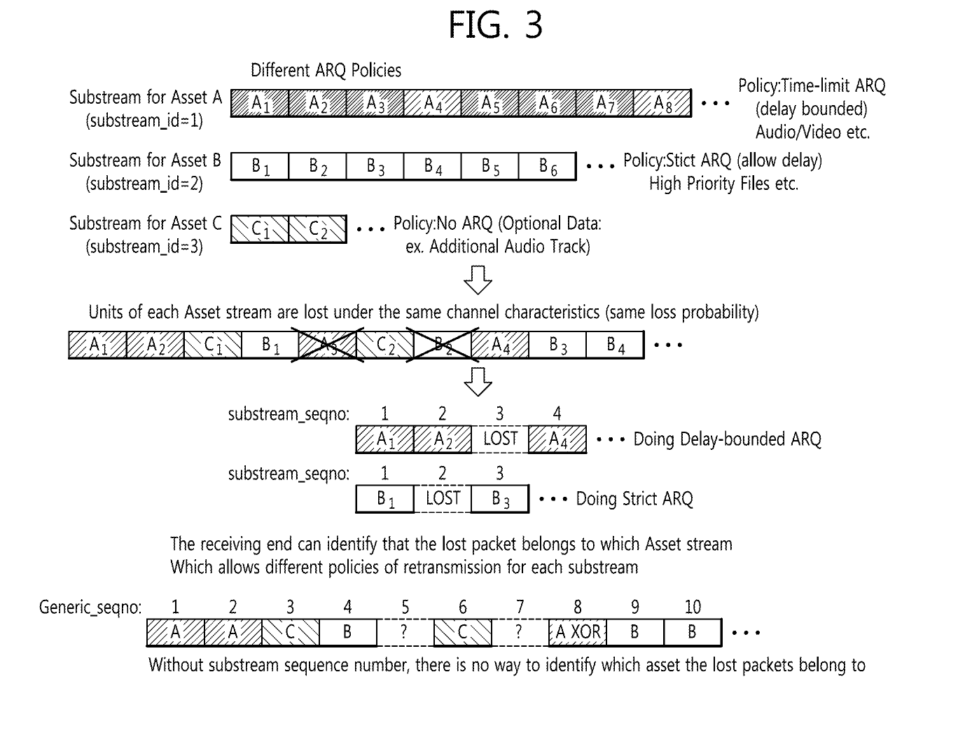

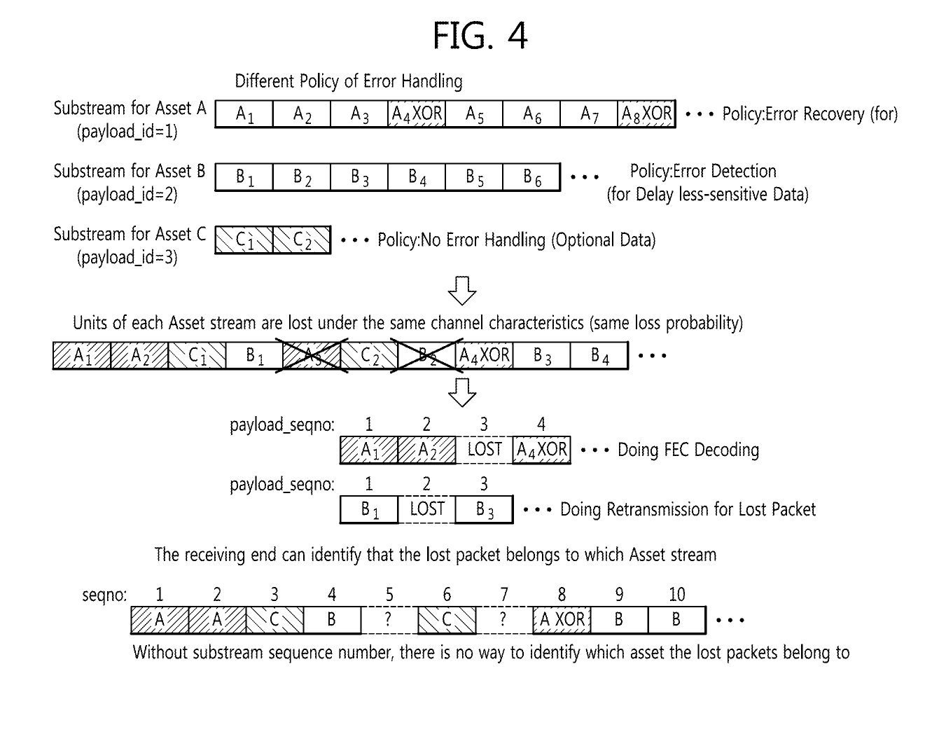

FIGS. 3 and 4 illustrate a concept of the substream_seqno field and the generic_seqno field and use cases of the substream_seqno.

Referring to FIGS. 3 and 4, in a case in which three substreams having different substream_IDs are multiplexed and transmitted to a single port, the use of the substream_seqno field allows a receiver to easily recognize a substream to which a lost packet belongs before it was initially multiplexed, although a packet loss occurs. Thus, in case of using the substream_seqno field together with the substream_ID field, different ARQ policies or error handling procedure may be executed for each substream.

In FIGS. 3 and 4, the substream A (substream_id=1) includes data susceptible to time delay, for example, and in this case, an ARQ policy having time limitation may be used. The substream B (substream_id=2) may include data such as a file, for which a packet error should not occur, although it is not susceptible to time delay, for example, and in this case, a packet error recovery policy without a time limitation may be independently used. The substream C (substream_id=3) may include data which is not relatively important, for example, and in this case, a packet error policy may not be executed to reduce complexity. According to an embodiment of the present invention, as in the foregoing examples, advantageously, different ARQ and error control policies may be individually executed for each subframe by using the substream_ID field and the substream_seqno field.

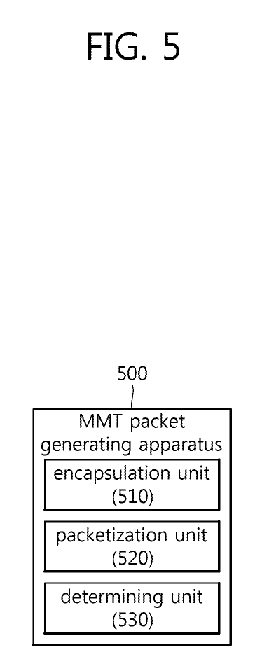

FIG. 5 is a block diagram of an apparatus for generating an MMT packet (or an MMT packet generating apparatus) according to an embodiment of the present invention. Referring to FIG. 5, the MMT packet generating apparatus 500 according to an embodiment of the present invention may include an encapsulation unit 510, a packetization unit 520, and a determining unit 530.

The encapsulation unit 510 encapsulates an AU to generate an MPU, and the packetization unit 520 packetizes the generated MPU to generate an MMT packet. For example, the packetization unit 520 may generate an MMT asset on the basis of the MPU, and may generate an MMT packet on the basis of the MMT asset. The generated MMT packet may have a packet header structure of any one of those of Table 1 to Table 4.

The MMT packet generated by the packetization unit 520 may be transmitted from a transmitting side to a receiving side via a network. In this case, respective streams with respect to a plurality of MMT packets are multiplexed and transmitted to a single port, and accordingly, the receiving side may take different ARQ policies or error control policies for each substream on the basis of a substream sequence number and/or a general sequence number included in a header of each MMT packet.

Also, the determining unit 530 may determine whether to generate an MMT packet on the basis of at least one of the substream sequence number and the general sequence number. Also, the determining unit 530 may determine whether the substream sequence number or the general sequence number is basically or optionally included in the MMT packet.

The determining unit 530 may determine whether to configure a header 1) by using both a substream sequence number and a general sequence number, 2) by optionally using a substream sequence number and basically using a general sequence number, 3) by basically using a substream sequence number and optionally using a general sequence number, or 4) by using only a substream sequence number. The determining unit 510 may determine any one of 1) to 4) in consideration of susceptibility regarding time delay or data loss, and the like.

The foregoing embodiments and advantages are merely exemplary and are not to be considered as limiting the present disclosure. It will be apparent to those skilled in the art that modifications and variations can be made without departing from the spirit and scope of the invention. This description is intended to be illustrative, and not to limit the scope of the claims. Also, although an embodiment has not been described in the above disclosure, it should be extensively construed within the scope of the technical concept defined in the claims. And, various changes and modifications that fall within the scope of the claims, or equivalents of such scope are therefore intended to be embraced by the appended claims

1. An MMT (MPEG Media Transport) packet generating apparatus comprising:
an asset generation unit configured to generate an asset based on an MPU (Media Processing Unit); and
a packetization unit configured to generate an MMT packet by packetizing the MPU in the asset,
wherein the packetization unit generates the MMT packet by including an identifier to distinguish the asset having different characteristics in a packet header.

2. The MMT packet generating apparatus of claim 1, wherein the identifier is included in a packet id field in the packet header.

3. The MMT packet generating apparatus of claim 1, wherein the identifier has 16 bit size.

4. The MMT packet generating apparatus of claim 1, wherein the packetization unit generates the MMT packet by including a sequence number used to distinguish packets having same identifier in the packet header.

5. The MMT packet generating apparatus of claim 4, wherein the sequence number is increased by 1 in every packet.

6. The MMT packet generating apparatus of claim 4, wherein the sequence number is included in a packet sequence number field in the packer header.

7. The MMT packet generating apparatus of claim 1, wherein the packetizing unit generates the MMT packet by including a counter number to count the packet by increasing by 1 according to numerical order in which the packet is delivered in the packet header.

8. The MMT packet generating apparatus of claim 7, wherein the counter number is included in a packet counter field in the packer header.

9. A method for generating a packet by an MMT (MPEG Media Transport) packet generating apparatus, the method comprising:
generating an asset based on an MPU (Media Processing Unit); and
generating an MMT packet by packetizing the MPU in the asset,
wherein the generating the MMT packet comprises generating the MMT packet by including an identifier to distinguish the asset having different characteristics in a packet header.

10. The method of claim 9, wherein the identifier is included in packet id field in the packet header.

11. The method of claim 9, wherein the identifier has 16 bit size.

12. The method of claim 9, wherein the generating the MMT packet comprises generating the MMT packet by including sequence number used to distinguish packets having the same identifier in the packet header.

13. The method of claim 12, wherein the sequence number is increased by 1 in every packet.

14. The method of claim 12, wherein the sequence number is included in a packet_sequence_number field in the packet header.

15. The method of claim 9, wherein the generating the MMT packet comprises generating the MMT packet by including a counter number to count the packet by increasing by 1 according to a numerical order in which the packet is delivered in the packet header.

16. The method of claim 15, wherein the counter number is included in a packet_counter field in the packet header.
